(19) United States
(12) Patent Application Publication
(10) Pub. No.: US 2020/0102458 A1
(43) Pub. Date: Apr. 2, 2020

(54) Cool Roof Coating Containing Multifunctional Additive

(71) Applicant: ICL Specialty Products Inc., St. Louis, MO (US)

(72) Inventors: Mussie Alemseghed, St. Louis, MO (US); Tony Gichuhi, St. Louis, MO (US); Michelle Bauer, St. Louis, MO (US); Nathan Kofira, St. Louis, MO (US)

(21) Appl. No.: 16/394,716

(22) Filed: Apr. 25, 2019

Related U.S. Application Data
(60) Provisional application No. 62/738,458, filed on Sep. 28, 2018.

(51) Int. Cl. C09D 5/33; C09D 5/08; C09D 7/40; C09D 7/61; C09D 133/04; C09D 183/04; C09D 123/22; C09D 125/06; C09D 175/04; E04D 7/00

(52) U.S. Cl. CPC C09D 5/004; C09D 5/08; C09D 7/69; C09D 7/61; C09D 133/04; C08K 2003/325; C09D 123/22; C09D 125/06; C09D 175/04; E04D 7/00; C09D 183/04

(57) ABSTRACT

Provided herein are compositions and methods for the use of anhydrous tricalcium phosphate as a multifunctional additive to coatings, such as paint systems, to provide a coating that provides improved solar reflectance and thermal emittance properties, improved dirt pick-up resistance, and enhanced corrosion protection.

### BACKGROUND

Reflective roof coatings or cool roof coatings have existed for over forty years. The first coatings developed achieved a roof cooling effect through the inclusion of aluminum flake pigments that reflected the radiation away from the structure. Advancements in polymer technology, primarily acrylic polymers whose modifications have lent themselves to a more elastomeric nature, but also in pre-manufactured membranes, has given rise to an area of increasing demand for further enhancements to solar reflectivity and radiant emissions, and in some cases, fire protection. Current improvements to achieving a high level of sustained reflectivity after years of the coating being in service is sought for low slope applications to combat the effects of dirt pick-up and mildew growth. Residential high slope roof coatings are primarily produced as shingles where additives are coated onto the roof granules to increase the reflectivity while maintaining the ability to impart color as consumers want added functionality with a traditional aesthetic.

It is common knowledge that the performance of a coating depends on the properties of its components including the binder, additives, and pigments. A typical solar spectrum, which is the source of energy, hits the substrate surface in different wavelength bands: UV (300-400 nm), visible (410-722 nm) and near IR (724-2500 nm), accounting for approximately 5%, 43%, and 52% of solar power, respectively. As more photons strike the surface (roof, wall etc.) they break more molecular bonds of the material leading to deterioration. The most damaging photons are UV photons since they have the highest energy. Typically, coating formulations are formulated to reflect VIS and near IR photons, which accounts for around 95% of solar spectrum. The use of infrared (IR) reflective pigments in coatings reduces the temperature of the coating and substrate by lowering the energy absorption from the sunlight. The lower temperature protects the substrate and coating from thermal degradation. Coatings containing infrared reflective pigments are now finding use in roof coatings. Some of the benefits provided by infrared reflective roof coatings include: enhanced coating weatherability as a result of reduced thermal degradation; less heat transfer into buildings; lower energy demand resulting from reduced use of air conditioning; reduced air pollution due to reduced energy consumption for air conditioning; improved ergonomics as a result of cooler roofs; and cooler outdoor urban air temperatures resulting from decreased use of air conditioning. White pigmented coatings have been shown to reflect about 75% of incident sunlight energy while conventional black pigmented coatings reflect as little as 3% of incident sunlight energy. New technology utilizing mixed metal oxide pigments now yields black colored coatings capable of reflecting more than 25% of incident sunlight energy.

In order to meet the standards set forth in the legislation, such as California Title 24, there exists a need for additives which can further increase the IR Reflectance and radiant emissions of these coatings. Additionally, as the market for cool roof coatings expands beyond commercial buildings to residential, additives which can still improve both reflectance and radiant emissions in both white and non-white coatings are needed. Thus, there remains a need to develop new pigments and thus coatings with increased solar reflectance in additional to properties such as improved dirt pick-up resistance and corrosion resistance.

### SUMMARY

Provided for herein are coating compositions comprising a binder and a anhydrous tricalcium phosphate (TCP) multifunctional additive. In certain aspects, the TCP is selected from the group consisting of Ca₅OH(PO₄)₃, Ca₁₀(OH)₂(PO₄)₆, and Ca₃(PO₄)₂. In certain aspects, the multifunctional additive is in an amount of from about 1% to about 99% (by total weight) or is in an amount of any of about 5%, 10% or 15% (by total weight) to any of about 10%, 15%, or 20% (by total weight) of the coating.

In certain aspects, the TCP multifunctional additive is a high surface area, micronized TCP multifunctional additive. In certain aspects, the TCP multifunctional additive has a particle size range of D₅₀ (1-5) micrometers and/or D₉₀ (10-100) micrometers, or the TCP multifunctional additive has a particle size range of D₉₀ (10-25) micrometers. In certain aspects, the TCP multifunctional additive has a refractive index of about 1.5 to 1.7, optionally wherein the TCP multifunctional additive has a refractive index of about 1.5, 1.6, or 1.7, optionally wherein the TCP multifunctional additive has a refractive index of about 1.6. In certain aspects, the TCP multifunctional additive has a specific surface area of 50 m²/g to 65 m²/g, optionally wherein the TCP multifunctional additive has a specific surface area of 59.92 m²/g.

In certain aspects, the binder comprises an acrylic elastomer, resin, silicone, butyl rubber, styrenated acrylic elastomers, or polyurethane. In certain aspects, the coating is an elastomeric roof coating (ERC). In certain aspects, the coating comprises a pigment that is not the TCP multifunctional additive. In certain aspects, the coating is a white elastomeric roof coating or wherein the coating is a colored elastomeric roof coating. In certain aspects, the pigment that is not the TCP multifunctional additive is titanium dioxide (TiO₂). In certain aspects, the pigment that is not the TCP multifunctional additive is an infrared reflective heavy metal pigment, for example the pigment that is not the TCP multifunctional additive is chromium oxide or iron oxide.

Provided for herein are methods of producing a solar reflective coating comprising incorporating a high surface area, micronized anhydrous TCP multifunctional additive into the coating's formulation. In certain aspects, the coating produced is a coating disclosed anywhere herein. In certain aspects, the TCP multifunctional additive has one or more of:

(i) a particle size range of about D₅₀ (1-5) micrometers and about D₉₀ (10-100) micrometers, optionally a particle size range of D₉₀ (10-25) micrometers;

(ii) a refractive index of about 1.6; and/or

(iii) a specific surface area of 59.92 m²/g.

Provided for herein are methods of improving the performance of a coating incorporating a high surface area, micronized anhydrous TCP multifunctional additive, as disclosed anywhere herein, into the coating's formulation. In certain aspects, the TCP multifunctional additive has one or more of:

(i) a particle size range of about D₅₀ (1-5) micrometers and about D₉₀ (10-100) micrometers, optionally a particle size range of D₉₀ (10-25) micrometers;

(ii) a refractive index of about 1.6; and/or

(iii) a specific surface area of 59.92 m²/g.

Provided for herein are methods of coating a substrate, the method comprising applying a coating composition, as disclosed herein, to a surface of the substrate. In certain aspects, the coating is applied directly to the surface of the substrate without the use of a primer layer between the substrate and the coating. In certain aspects, the coating is applied in a single layer. In certain aspects, the coating is applied to the surface at a dry film thickness of from about 300 microns to about 500 microns. In certain aspects, the substrate is concrete, metal, polyurethane foam, wood, asphalt shingle, or rubber, optionally wherein the metal is cold-rolled steel, aluminum, or galvanized steel. In certain aspects, the substrate to which the coating is applied is part of a roof. In certain aspects, the roof is a low-slope roof or a residential high-slope roof

Also provided for herein is a roof surface adhered to a coating composition as disclosed anywhere herein. In certain aspects, the roof is a metal roof. In certain aspects, the surface is adhered directly to the coating without the use of a primer layer between surface and the coating. In certain aspects, the coating has a dry film thickness of from about 300 microns to about 500 microns. In certain aspects, the roof is a commercial low-slope roof or a residential high-slope roof.

For any of the coatings disclosed anywhere herein, in certain aspects the coating has one or more of:

(i) improved solar reflectance;

(ii) improved thermal emittance;

(iii) improved dirt pick-up resistance; and

(iv) improved corrosion protection,

when applied to a substrate in comparison to a control coating.

In certain aspects, the control coating comprises the same basic composition except for having calcium carbonate in place of the TCP multifunctional additive. In certain aspects, the improvement in solar reflectance is an increase of at least about 1%, 1.5%, 2%, or 2.5% over the control coating as measured by ASTM C1549. In certain aspects, the improvement in solar reflectance is an increase of at least about 1%, 1.5%, 2%, or 2.5% over the control coating as measured by ASTM C1549 after accelerated weathering under ASTM G155-13 (1,000 hours). In certain aspects, the improvement in dirt pick-up resistance is evidenced by an improvement in solar reflectance after soiling under ASTM D7897, that is an increase of at least about 1.0%, 1.5%, 2.0%, 2.5%, or 3.0% over the control coating as measured by ASTM C1549.

In certain aspects, the coating passes the low temperature flexibility test ASTM D6083-05/D522, optionally wherein the coating passes the low temperature flexibility test ASTM D6083-05/D522 after accelerated weathering under ASTM G155 (1,000 hours). In certain aspects, the coating provides corrosion resistance in accordance to ASTM B117-16. In certain aspects, the coating has a total solar reflectance of at least about 83%, 83.5%, 84%, 84.5%, or 85% as measured by ASTM C1549. In certain aspects, the coating has a thermal emittance of at least about 90%, 91%, or 92% as measured by ASTM C1371-15.

In certain aspects, the coating provides the improved solar reflectance, improved thermal emittance, improved dirt pick-up resistance, and/or improved corrosion protection when applied directly to the substrate without the use of a primer layer between the substrate and the coating. In certain aspects, the coating provides the improved solar reflectance, improved thermal emittance, improved dirt pick-up resistance, and/or improved corrosion protection when applied to the substrate in a single-layer. In certain aspects, the coating provides the improved solar reflectance, improved thermal emittance, improved dirt pick-up resistance, and/or improved corrosion protection when the coating has a dry film thickness of from about 300 microns to about 500 microns.

### BRIEF DESCRIPTION OF THE DRAWINGS/FIGURES

FIG. 1. FIG. 1 shows corrosion test results using 5 wt. % of TCP.

### DETAILED DESCRIPTION

To the extent necessary to provide descriptive support, the subject matter and/or text of the appended claims is incorporated herein by reference in their entirety.

It will be understood by all readers of this written description that the exemplary aspects and embodiments described and claimed herein may be suitably practiced in the absence of any recited feature, element or step that is, or is not, specifically disclosed herein.

It is to be noted that the term “a” or “an” entity refers to one or more of that entity; for example, “a coating,” is understood to represent one or more coatings. As such, the terms “a” (or “an”), “one or more,” and “at least one” can be used interchangeably herein.

Furthermore, “and/or” where used herein is to be taken as specific disclosure of each of the specified features or components with or without the other. Thus, the term and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

Unless defined otherwise, technical and scientific terms used herein have the same meaning as commonly understood by one of ordinary skill in the art to which this disclosure is related. Numeric ranges are inclusive of the numbers defining the range. Even when not explicitly identified by “and any range in between,” or the like, where a list of values is recited, e.g., 1, 2, 3, or 4, unless otherwise stated, the disclosure specifically includes any range in between the values, e.g., 1 to 3, 1 to 4, 2 to 4, etc.

The headings provided herein are solely for ease of reference and are not limitations of the various aspects or aspects of the disclosure, which can be had by reference to the specification as a whole.

As used herein, a “low-slope” roof has a slope of less than or equal to 4 inches of vertical rise for every 12 inches of horizontal length (4:12). A “high-slope” roof is a roof steeper than a low-slope roof as defined herein.

### Overview

Provided herein are methods for the use of anhydrous tricalcium phosphate (aka, TCP or Hydroxyapatite or HAP, or Ca₅OH(PO₄)₃ or Ca₁₀(OH)₂(PO₄)₆, or Ca₃(PO₄)₂ or tribasic calcium phosphate or bone phosphate of lime and all its crystalline polymorphs) as a multifunctional additive to coatings, such as paint systems, to provide a coating that provides improved solar reflectance and thermal emittance properties, improved dirt pick-up resistance, and enhanced corrosion protection. Cool roofs using such coatings reduce building energy consumption, lower roof maintenance costs, and extend the lifetime of the roof. In certain aspects, the coating is applied as one-layer.

In certain aspects, the TCP is a high surface area, micronized TCP. As disclosed herein, TCP can be used as a multifunctional additive in elastomeric roof coating (ERC) applications for low-slope roofs (e.g., commercial) and high-slope roofs (e.g., residential). ERCs are designed to provide solar reflectance and improve thermal emittance from the sun's radiant heat (IR, UV), thus keeping the roof cooler. Coatings are made reflective using functional pigments added to the coating. These pigments include, but are not limited to, titanium dioxide and calcium carbonate. Cool roofs are applied to many substrates, metal and concrete being the most common.

Additives typically make up <5% of the total formulation comprised of dispersants, defoamers, mildewcides, and surfactants, some of which are phosphate based, such as potassium tripolyphosphate (KTPP) and phosphate esters. Currently used formulations designed to be applied on-site are typically derived from acrylic elastomers and contain a small amount of titanium dioxide (TiO₂) and a larger proportion of calcium carbonate (CaCO₃) to keep the costs down while providing enough hiding power and solar reflectivity. The use of predominantly TiO₂ allows for the use of such simple dispersants such as KTPP (potassium tripolyphosphate). Certain aspects of this disclosure do not replace TiO₂, but provide for an additive that enhances the reflectivity and/or emissivity property of the final coating/paint. Certain aspects of a multifunctional additive further provide benefits to certain areas specific to the substrate being coated. For example, one of the major challenges of commercial (low slope) coatings is water ponding. Not only does the accumulation of water lead to ideal conditions for the growth of mildew, but it provides a collection point for dirt which reduces the overall reflectivity of the roof during its service life. As disclosed in the Examples herein, both lab-scale and accelerated experiments were performed to evaluate coated samples comprising a multifunctional TCP additive. Reflectance measurements were acquired using solar reflectometer. Aging experiments were also performed on coated samples using a Weatherometer to evaluate the impact on the measured solar reflectance. The results confirmed increased IR and radiant performance while battling conditions associated with water ponding. This is a step towards meeting legislative requirements by retaining the reflectivity over the lifetime of the coating. Much of the remaining formulation (>30%) aside from the acrylic resin was TiO₂ and extender pigments such as calcium carbonate. TiO₂ maintains a high IR reflectance while extender pigments provide reduced cost while also boosting the desired properties of a cool roof. Certain aspects provided a higher Refractive Index and specific surface area than CaCO₃ and provided additional benefits by increasing the solar reflectance and thermal emittance of the coating. Specific to commercial (low slope) roof coatings applied over metallic roofs is the concern of rust prevention. Certain aspects enhanced the anti-corrosion properties of the final coating.

Metal roofs corrode easily and as a result a primer layer must be employed underneath the elastomeric roof coating (ERC). Current technologies in practice primarily use TiO₂ and calcium carbonate (CaCO₃) and therefore provide no corrosion resistance to the final paint. In certain aspects, a multifunction TCP additive provides corrosion protection. In certain aspects, a multifunction TCP additive eliminates the need for a metal primer altogether. Multifunctional TCP additives boost solar reflectance, thermal emittance, and also reduces dirt pick-up on the coating as dirt pickup (from pollutants such as smog, dust, soil, etc.) is a major culprit for such coatings.

As disclosed in the non-limiting representative Examples disclosed below, several industrial roofing paints were prepared using TCP with a range of dosages from 0% (control), 5%, 10% to 15% (by total weight of paint). As compared to a control composition, calcium carbonate was partially replaced with TCP at 5% increments while keeping the total pigment volume concentration (PVC) constant. Paints were applied to corrodible metal coupons and analyzed for solar reflectance and thermal emittance. Initial Xenon Arc tests showed an improved solar reflectance and thermal emittance with increasing levels of TCP. Accelerated weathering (ASTM G155-13 after 1,000 hours) with post-exposure Solar Reflectance (ASTM C1549) and Thermal Emittance (ASTM C1371-15) tests showed 82.0%, 83.4% and 84.4% total solar reflectance values respectively for the above three TCP loading levels. The control showed 82.0% for the same test. The final coating with TCP also showed excellent dirt pick-up resistance achieving 82.3% Solar Reflectance for the 15% TCP vs 79.2% for the control which showed more deterioration in solar reflectivity after 1000 hours of accelerated weathering and soiling/dirt pick-up.

Certain aspects also offered superior corrosion resistance as measured by salt spray (ASTM B 117), in addition to the enhanced solar reflectivity property. Current practice is to use a primer coat to provide the corrosion resistance when recoating refurbished or corroded metal roofs. This is followed by the white elastomeric roof coating. In certain aspects, a TCP additive eliminates the need for the primer. It thus allows the user to eliminate the need for a secondary primer layer when coating over steel or galvanized roofs and boosts total solar reflectance (TSR) for new and aged coatings. The elimination of the secondary primer layer provides significant labor, time and material savings since only one product needs to be applied to the roof. Contractors no longer need to carry two different products or apply a primer first followed by the ERC. One paint does the job.

As also disclosed in the Examples, the low temperature flexibility test ASTM D6083-05 after 1,000 hours of accelerated weathered samples was evaluated. TCP containing coatings passed the test with no cracking.

In certain aspects, the multifunctional additive (and thus in certain aspects the coating) is heavy metal free. This positively contributes to the design of paints used for Green Buildings (as defined by the United States Green Building Council, USGBC) by reducing energy consumption (i.e. increased higher solar reflectance), improving indoor human health (via reduced demand for air conditioning) and through the better selection of sustainable materials (no heavy metals) which are more ecofriendly.

Certain aspects disclosed herein provide for solar reflective elastomeric roof coatings for both low-slope and high-slope roofs.

### TCP

As used herein, TCP refers to a grade of tricalcium phosphate that was developed for use in various industrial applications that require a high-quality product with a very uniform and narrow particle size distribution. TCP is a white, crystalline powder ranging in appearance from fluffy to a dense material that appears to flow well and will generally not clump up. In certain aspects, it has a particle size range of D₅₀ (1-5) micrometers and/or D₉₀ (10-100) micrometers. For elastomeric roof coating applications, a smaller particle size allows for easier dispersion in paint, less energy, and higher production throughput of the final paint. Thus, in certain aspects, the TCP has a particle size range of D₉₀ (10-25) micrometers.

Previous work has shown that tricalcium phosphate is insoluble in water. TCP has the ability to form a very stable suspension slurry that can be easily handled and pumped. The TCP slurry is characterized by a neutral pH. These properties find utility by making TCP a very good suspension/dispersing agent for other materials. Another particularly useful property of TCP is its ability to adsorb moisture on its surface and remain a free-flowing powder.

One characteristic of a desired reflective coating is a high total solar reflectance (TSR), which is typically ≥75%, and low heat build-up (heat accumulation). Other characteristics such as, dirt-pick up, compatibility with other paint ingredients and weathering were also considered important. For an additive to be considered for cool roof applications, it typically must be white in color or have a high refractive index. This helps to reflect the incident light upon contact with the substrate. TCP is a white crystalline powder with a refractive index of around 1.6, ranging in appearance from fluffy to a dense material that is easily dispersed in paint.

It was observed that TCP helps to uniformly disperse and scatter Titanium dioxide (TiO₂). As described herein, calcium carbonate was replaced by TCP at an increment of 5 wt % in an elastomeric roof coating formula. BET measurement showed that TCP has higher specific surface area when compared to CaCO₃ (for example, measured as 59.92 m²/g for TCP vs 1.34 m²/g for CaCO₃). This means, in a composition of this disclosure, a pigment with a small surface area (CaCO₃) was replaced with TCP which has much higher surface area. This contributed to morphological structural changes of the new elastomeric coating and increased the surface roughness. This high degree of surface roughness provides very small contact area between the surface and contaminant, and thus improves dirt-pick resistance. A rough surface (with higher surface area) also has low surface energy which leads to a high contact angle which therefore resist wetting and adherence of dirt contaminants. Without dirt pick-up resistance, the roof coating would quickly darken with age. Because dark materials tend to absorb heat, dirt pick-up can significantly increase a roof's surface temperatures, which in turn increases interior temperatures and energy costs. TCP-based coatings, however, are demonstrated herein to resist dirt pick-up, and retain their white, reflective appearance. Surface roughness and low surface energy help contribute to the low dirt pick-up.

### Coating

Provided for herein in is a coating composition comprising a binder and an anhydrous tricalcium phosphate (TCP) multifunctional additive. In certain aspects, the TCP multifunctional additive has the chemical formula Ca₅OH(PO₄)₃, Ca₁₀(OH)₂(PO₄)₆, and/or Ca₃(PO₄)₂. In certain aspects, the TCP multifunctional additive is in an amount of from about 1% to about 99% by total weight of the coating composition. In certain aspects, the multifunctional additive is in an amount of any of about 1%, 2%, 3%, 4%, 5%, 10%, 15%, 20%, 25%, 30%, or 40% (by total weight) to any of about 2%, 3%, 4%, 5%, 10%, 15%, 20%, 25%, 30%, 40%, or 50% (by total weight) of the coating. In certain aspects, the multifunctional additive is in an amount of any of about 1%, 5%, 10% or 15% (by total weight) to any of about 5%, 10%, 15%, or 20% (by total weight) of the coating.

In certain aspects, the TCP multifunctional additive is a high surface area, micronized TCP multifunctional additive. Micronization is the process of reducing the particle size of a material into the micron range (1 μm=1×10⁻⁶ m). One of ordinary skill in the art will appreciate that when a particle is micronized into smaller parts, the overall volume does not change, but the surface area increases dramatically. Therefore, in certain aspects, a micronized TCP multifunctional additive has a high surface area. In certain aspects, a high surface area TCP multifunctional additive is micronized. In certain aspects, the multifunctional additive has a particle size range of D₅₀ (1-5) micrometers and/or D₉₀ (10-100) micrometers. In certain aspects, the multifunctional additive has a particle size range of D₅₀ (1-5) micrometers and D₉₀ (10-100) micrometers. In certain aspects, the multifunctional additive has a particle size range of D₉₀ (10-25) micrometers. Particle sizing was determined by laser diffraction which works on the principle that when a beam of light (e.g., a laser) is scattered by a group of particles, the angle of light scattering is inversely proportional to particle size, i.e., the smaller the particle size, the larger the angle of light scattering. Measurements in the representative Examples were performed with a HORIBA Laser Particle Size Analyzer.

In certain aspects, the TCP multifunctional additive has a refractive index of about 1.5 to 1.7. For example, about 1.5, 1.6, or 1.7. In certain aspect, the multifunctional additive has a refractive index of about 1.6. Refractive index (RI) is defined as the ratio of the speed of light in a vacuum compared to the speed of light in a substance. Determination of refractive index was performed by immersion method. The sample was mounted in a liquid of a known index. Microscopical techniques (Becke line and relief methods) were used to identify the relation between the refractive index of the sample and the liquid. The examination was repeated until the refractive index of the liquid best matched that of the sample. Intervals of refractive index liquids used was 0.004. Thus, the measurement uncertainty resulting from the index liquids was approximately ±0.002. Table 1 shows refractive indices for pigment and vehicles used in the manufacture of paint.

TABLE 1
Refractive Indices (R.I.) for Pigments and Vehicles Used
in the Manufacture of Paint.

| | R.I. |
|---|---|
| White Pigments | |
| Diatomaceous earth | 1.45 |
| Silica | 1.45-1.49 |
| Calcium carbonate | 1.63 |
| Barytes | 1.64 |
| Clay | 1.65 |
| Magnesium silicate | 1.65 |
| Lithopone | 1.84 |
| Zinc oxide | 2.02 |
| Antimony oxide | 2.09-2.29 |
| Zinc sulfide | 2.37 |
| Titanium dioxide (anatase) | 2.55 |
| Titanium dioxide (rutile) | 2.73 |
| Vehicles or Media | |
| Vacuum | 1.0000 |
| Air | 1.0003 |
| Water | 1.3330 |
| Polyvinyl acetate resin | 1.47 |
| Soybean oil | 1.48 |
| Refined linseed oil | 1.48 |
| Vinyl resin | 1.48 |
| Acrylic resin | 1.49 |
| Tung oil | 1.52 |
| Oxidizing soya alkyd | 1.52-1.53 |
| Styrene butadiene resin | 1.53 |
| Alkyd/melamine (75/25) | 1.55 |

$$Refractive Index = \frac{Speed \text{-} of \text{-} light \text{-} in \text{-} vacuum}{Speed \text{-} of \text{-} light \text{-} in \text{-} substance}$$

In certain aspects, the TCP multifunctional additive has a specific surface area of 50 m²/g to 65 m²/g. For example, in certain aspects, the multifunctional additive has a specific surface area of 59.92 m²/g. Surface area was measured using nitrogen adsorption which detects total surface area of the particles. To find surface area, the amount of N₂ adsorbed to the surface in a single layer was “simply” determined.

In certain aspects of the coating, the binder comprises an acrylic elastomer, resin, silicone, butyl rubber, styrenated acrylic elastomers, or polyurethane. In certain aspects, the coating contains one or more additional components, such as but not limited to, those shown in the representative coating formulation in Table 2. One of ordinary skill in the art will know various coating formulations and/or other components of coatings that may be incorporated into the coating compositions of this disclosure. In certain aspects, the coating contains additives such as dispersants, defoamers, mildewcides, and surfactants. In certain aspects, the coating comprises a pigment that is not the TCP multifunctional additive. In certain aspects, the pigment that is not the TCP multifunctional additive is an infrared reflective heavy metal pigment. For example, in certain aspects, the pigment that is not the TCP multifunctional additive is chromium oxide or iron oxide. In certain aspects, the pigment that is not the TCP multifunctional additive is titanium dioxide (TiO₂).

In certain aspects, the coating is an elastomeric roof coating (ERC). For example, in certain aspects, the coating is a white elastomeric roof coating. In certain other aspects, the coating is a colored elastomeric roof coating. In certain aspects, the ERC is can be applied/is applied to a low-slope roof. In certain aspects, the ERC is can be applied/is applied to a high-slope roof. Additional/more specific uses and properties of any of the above coatings are described in more detail below.

### Method of Producing a Coating

Also provided for herein is a method of producing a solar reflective coating. In certain aspects, the method comprises incorporating an anhydrous TCP multifunctional additive as disclosed anywhere herein into the coating's formula.

### Method of Producing a Coating

Also provided for herein is a method of improving the performance of a coating. In certain aspects, the method comprises incorporating an anhydrous TCP multifunctional additive as disclosed anywhere herein into the coating's formulation.

### Method of Coating a Substrate

Also provided for herein is a method of coating a substrate to, for example, increase solar reflectivity and/or provide corrosion control. In certain aspects, the method comprises applying a coating composition comprising a TCP multifunctional additive as disclosed anywhere herein to a substrate. Representative examples of suitable substrates include, but are not limited to, concrete, metal, polyurethane foam, wood, asphalt shingle, or rubber. In certain aspects, the metal is cold-rolled steel, aluminum, or galvanized steel. Current practice is to use a primer coat to, for example, provide corrosion resistance. In certain aspects disclosed herein, the coating can be applied directly to the surface of the substrate without the use of a primer layer between the substrate and the coating. In certain aspects disclosed herein, the coating is applied directly to the surface of the substrate without the use of a primer layer between the substrate and the coating. Further, in certain aspects, the coating can be applied in a single layer. In certain aspects, the coating is applied in a single layer. In certain aspects, the coating is applied to the surface of the substrate at a dry film thickness of from about 200 or 250 microns to about 750 or 800 microns. In certain aspects, the coating is applied to the surface of the substrate at a dry film thickness of from about 250 or 300 microns to about 700 or 750 microns. In certain aspects, the coating is applied to the surface of the substrate at a dry film thickness of from about 250 or 300 microns to about 500 or 600 microns. In certain aspects, the coating is applied to the surface of the substrate at a dry film thickness of from about 300 microns to about 500 microns.

In certain aspects, the substrate to which the coating is applied is part of a roof. In certain aspects, the roof if a metal roof, a wood roof, or an asphalt shingle roof. In certain aspects, the roof is a metal roof. In certain aspects, the roof is a low-slope roof and in certain aspects the low-slope roof is a commercial roof. In certain aspects, the roof is a high-slope roof and in certain aspects, the high-slope roof is a residential roof.

### Roofs

Provided for herein is a roof surface. In certain aspects, the roof surface is adhered to a coating composition comprising a TCP multifunctional additive disclosed anywhere herein. In certain aspects, the roof if a metal roof, a wood roof, or an asphalt shingle roof. In certain aspects, the roof is a metal roof. In certain aspects, the roof surface is prepared by a method of coating a substrate as disclosed above. In certain aspects, the roof surface is adhered directly to the coating without the use of a primer layer between surface and the coating. In certain aspects, the coating adhered to the roof surface has a dry film thickness of from about 300 microns to about 500 microns. In certain aspects, the roof is a low-slope roof and in certain aspects the low-slope roof is a commercial roof. In certain aspects, the roof is a high-slope roof and in certain aspects, the high-slope roof is a residential roof.

### Coating Properties

The coatings disclosed and/or used anywhere herein have certain unique and improved properties including but not limited to those described below. In certain aspects when applied to a substrate, the coating has one or more of: (i) improved solar reflectance; (ii) improved thermal emittance; (iii) improved dirt pick-up resistance; and (iv) improved corrosion protection, in comparison to a “control” coating composition. In certain aspects, the coating provides the improved solar reflectance, improved thermal emittance, improved dirt pick-up resistance, and/or improved corrosion protection when applied directly to the substrate without the use of a primer layer between the substrate and the coating. In certain aspects, the coating provides the improved solar reflectance, improved thermal emittance, improved dirt pick-up resistance, and/or improved corrosion protection when applied in a single-layer. In certain aspects, the coating provides the improved solar reflectance, improved thermal emittance, improved dirt pick-up resistance, and/or improved corrosion protection when the coating has a dry film thickness of from about 300 microns to about 500 microns.

On of ordinary skill in the art will understand that a “control” coating composition is a composition, such as of a coating in current use, that is basically the same in composition of a coating composition of this disclosure except for the composition of this disclosure comprises a TCP multifunctional additive and the control does not. A representative control and TCP containing coating are shown in Table 2, wherein the addition of the 5% TCP multifunctional additive is achieved by replacing calcium carbonate in the control composition. One of ordinary skill in the art will understand that a control composition can vary slightly in components such as additives like surfactants and dispersants, but that these differences would not be expected to account for the changes in properties observed between the control and the coating composition of this disclosure (i.e., while the control coating composition is not exactly identical but for the addition of TCP, it is basically the same). As noted, in certain aspects, the control coating comprises the same basic composition except for having calcium carbonate in place of the TCP multifunctional additive.

In certain aspects, the improvement in solar reflectance is an increase over the control coating as measured by ASTM C1549 which is the Standard Test Method for Determination of Solar Reflectance Near Ambient Temperature Using a Portable Solar Reflectometer. In certain aspects, the improvement in solar reflectance is an increase of at least about 0.5%, 1.0%, 1.5%, 2.0%, 2.5%, or 3.0% over the control coating as measured by ASTM C1549. In certain aspects, the improvement in solar reflectance is measured after accelerated weathering under ASTM G155-13 (1,000 hours) which is the Standard Practice for Operating Xenon Arc Light Apparatus for Exposure of Non-Metallic Materials. In certain aspects, the improvement in solar reflectance is an increase of at least about 0.5%, 1.0%, 1.5%, 2.0%, 2.5%, or 3.0% over the control coating as measured by ASTM C1549 after accelerated weathering under ASTM G155 (1,000 hours).

In certain aspects, the improvement in dirt pick-up resistance is evidenced by an improvement in solar reflectance after soiling under ASTM D7897 (which is the Standard Practice for Laboratory Soiling and Weathering of Roofing Materials to Simulate Effects of Natural Exposure on Solar Reflectance and Thermal emittance), that is an increase of at least about 0.5%, 1.0%, 1.5%, 2.0%, 2.5%, or 3.0% over the control coating as measured by ASTM C1549.

In certain aspects, the coating passes the low temperature flexibility test ASTM D6083-05 (Standard Specification for Liquid Applied Acrylic Coating Used in Roofing)/D522 (Standard Test Methods for Mandrel Bend Test of Attached Organic Coatings). In certain aspects, the coating passes a low temperature flexibility test after accelerated weathering under ASTM G155 (1,000 hours).

In certain aspects, the coating provides corrosion resistance in accordance to ASTM B117-16 which is the Standard Practice for Operating Salt Spray (Fog) Apparatus.

In certain aspects, the coating has a total solar reflectance of at least about 83%, 83.5%, 84%, 84.5%, or 85% as measured by ASTM C1549, before or after weathering as described above. In certain aspects, the coating provides the above total solar reflectance without the use of a primer layer between the substrate and the coating. In certain aspects, the coating provides the above total solar reflectance when applied in a single-layer. In certain aspects the coating provides the above total solar reflectance when the coating has a dry film thickness of from about 300 microns to about 500 microns.

In certain aspects, the coating has a thermal emittance of at least about 90%, 91%, or 92% as measured by ASTM C1371-15, before or after weathering as described above. In certain aspects, the coating provides the above thermal emittance without the use of a primer layer between the substrate and the coating. In certain aspects, the coating provides the above thermal emittance when applied in a single-layer. In certain aspects the coating provides the above total thermal emittance when the coating has a dry film thickness of from about 300 microns to about 500 microns.

Further, TCP is not a heavy metal and does not contain any heavy metals. Most widely used products contain Zn, Sr, Cr, or Pb. The paint and coating industry has in many cases banned the use of Cr(VI). Thus, alternative options typically contain heavy metals such as Zn or Sr. In certain aspects, a coating of this disclosure does not contain Zn, Sr, Cr, and/or Pb. In certain aspects, a coating of this disclosure does not contain a heavy metal. In certain aspects, a coating of this disclosure that does not contain a heavy metal still exhibits one or more of the properties described above.

### EXAMPLES

Table 2 shows a Control elastomeric roof coating formulation and a non-limiting, representative formulation containing 5% TCP by weight. Similarly, formulations containing 10% and 15% by weight were also produced.

TABLE 2
Elastomeric Roof Coating Formula, for 5% TCP.

| | | | 5% TCP | |
|---|---|---|---|---|
| | | | Replacement of | |
| | Control | | calcium carbonate | |
| | lbs/100 gal | % wt | lbs/100 gal | % wt |
| GRIND | | | | |
| Water | 130.0 | 11.69 | 130.0 | 11.63 |
| Tamol 851 | 4.0 | 0.36 | 4.0 | 0.36 |
| Propylene Glycol | 6.0 | 0.54 | 6.0 | 0.54 |
| DEE FO 1015 | 1.0 | 0.09 | 1.0 | 0.09 |
| KTPP | 1.0 | 0.09 | 1.0 | 0.09 |
| Zoco 101 | 30.0 | 2.70 | 30.0 | 2.68 |
| Ti-Pure R-960 | 50.0 | 4.50 | 50.0 | 4.47 |
| TCP | 0.0 | 0.00 | 58.5 | 5.24 |
| HUBERCARB G3 | 270.0 | 24.29 | 217.2 | 19.44 |
| Water | 20.0 | 1.80 | 20.0 | 1.79 |
| LETDOWN | | | | |
| Rhoplex EC-2885 | 504.0 | 45.34 | 504.0 | 45.10 |
| Texanol | 6.5 | 0.58 | 6.5 | 0.58 |

Add grind portion under agitation and mix until uniform.

| | | | | |
|---|---|---|---|---|
| DEE FO 1015 | 6.0 | 0.54 | 6.0 | 0.54 |

Premix the following, then add to above under agitation.

| | | | | |
|---|---|---|---|---|
| Water | 75.2 | 6.76 | 75.2 | 6.73 |
| Natrosol 250 H4BR PA | 5.0 | 0.45 | 5.0 | 0.45 |
| Mix well for 10 minutes. | | | | |
| Ammonia Hydroxide | 3.0 | 0.27 | 3.0 | 0.27 |
| (28%) | | | | |
| TOTAL | 1111.70 | 100.00 | 1117.40 | 100.00 |

The coatings were applied to panels (in triplicate) and was air dried for 7 days on a laboratory bench. Panels were tested of total solar reflectance (ASTM C1549), thermal emittance (ASTM C1371), accelerated weathering with post-exposure solar reflectance, thermal emittance testing (1000 hours, Xenon Arc Q-Sun (ASTM G155), laboratory soiling and weathering (Dirt Pick-up Resistance, DPUR) with post-exposure Solar Reflectance and Thermal Emittance testing (ASTM D7897), low temperature flexibility test on 1,000 hour accelerated weathered samples (ASTM D6083/D522), and anticorrosion performance (tested separately).

TABLE 3
Summary of Analytical Test Results

| | | 5% | | 15% |
|---|---|---|---|---|
| Description | Control | TCP | 10% TCP | TCP |
| Initial | | | | |
| Solar Reflectance (ASTM C1549) | 0.826 | 0.832 | 0.839 | 0.848 |
| Thermal Emittance (ASTM C1371) | 0.89 | 0.90 | 0.90 | 0.90 |
| After ASTM G155 accelerated | | | | |
| weathering (1,000 h) | | | | |
| Solar Reflectance (ASTM C1549) | 0.820 | 0.820 | 0.834 | 0.844 |
| Thermal Emittance (ASTM C1371) | 0.90 | 0.91 | 0.91 | 0.92 |
| After ASTM D7897 “soiling” | | | | |
| Solar Reflectance (ASTM C1549) | 0.792 | 0.801 | 0.806 | 0.823 |
| Thermal Emittance (ASTM C1371) | 0.90 | 0.90 | 0.91 | 0.90 |
| Low temperature flexibility ASTM | | | | |
| D6083/D522 | | | | |
| Initial | Pass | Pass | Pass | Pass |
| After ASTM G155 accelerated | Pass | Pass | Pass | Pass |
| weathering (1,000 h) | | | | |
| Corrosion Resistance ASTM B 117 | | | | |
| Cold Rolled Steel (336 hours) | Fail | Pass | Pass | Pass |

Test results of the above examples demonstrated that final paint samples containing TCP showed increased solar reflectance, improved dirt pick-up as well as improved corrosion resistance. Samples varied based on loading level of TCP (0-15 wt. % on total formula weight, and on the PVC and volume solids of the coatings). The tested high-quality roof coatings have a PVC of 34 and weight solids of 57%. TCP was substituted into these formulas at 5% increments, replacing calcium carbonate. Test results (Table 3) showed that the total solar reflectance increased with increasing level of TCP. The control showed 82% TSR value while the paint with 5% TCP loading level showed a TSR of 83.2%. For the 10% TCP, TSR was 83.9% and the highest TSR values was observed with 15% TCP at 85%. TCP was used to increase the TSR of elastomeric roof coatings containing calcium carbonate and titanium dioxide, and the recommended loading levels are from 1-99%, based on total formula weight. As an anti-corrosive pigment, the ideal recommended loading levels range from 1-5% based on total formula weight.

Accelerated weathering test showed that panels performed excellent, with less level of degradation after 1000 hours UV exposure, and therefore the original total Solar Reflectance and Thermal Emittance values (before exposure) did not vary much after exposure. Dirt pick-up test also showed panels did not deteriorate after treatment of moisture and dirt in the chamber.

Refractive Index test results were also acquired, with 1.62 for TCP. For comparison purposes, BET surface area analysis of TCP was also acquired and compared to Hubercarb® G2 (CaCO₃) and was found to be much higher (59.92 m²/g vs 1.34 m²/g) respectively.

Low temperature elasticity test: Coatings for dimensionally unstable roofing substrates must have long-term, low-temperature flexibility. This is necessary to accommodate thermal expansion and contraction of the substrate, so that coatings will not fail over an extended period or with extreme weather conditions. It should be remembered that the effects of extreme weather conditions are not restricted to cold climates. Water contact after a sudden thunderstorm on a hot day in any geographic location can rapidly drop the roof temperature as much as 100°, causing severe thermal stress to the roof surface. All panels passed the low temperature elasticity test. Formulations containing TCP additives can withstand a 180° flexibility bend at −15° F. without cracking. Since there is no plasticizer to migrate from the system, this flexibility is retained over time. Long-term resistance to cracking can extend the life of the roof. It is important to note that elastomeric roof coatings should exhibit good mechanical properties at room and low temperatures before and after exterior exposure.

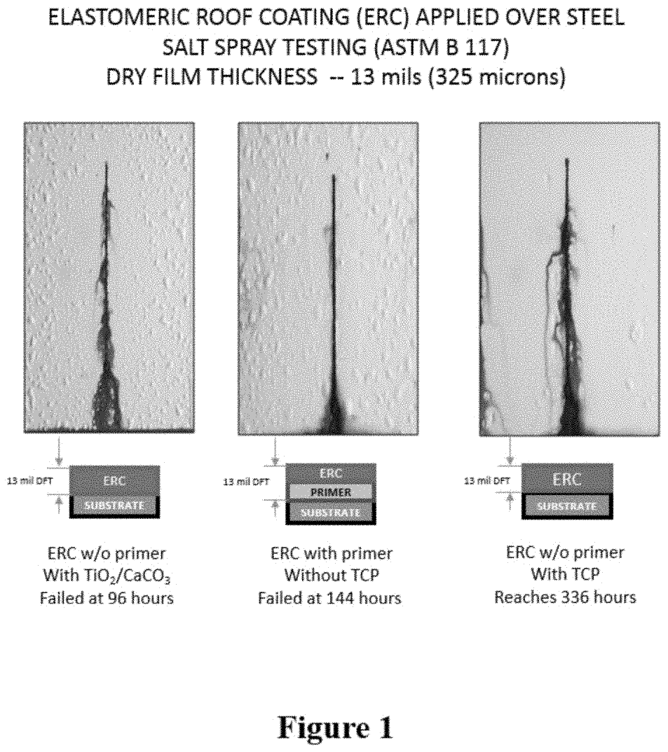

Corrosion testing of a one coat elastomeric roof coating (ERC) utilizing TCP versus a primer+ERC system was performed. At equal film thickness, a one-coat ERC system using 5% TCP provides improved adhesion properties versus the primer system, giving it better performance in salt spray over steel. Systems were tested with TCP included in the ERC only, in the primer only, and in both coats. The best performer, exceeding 336 hours of salt spray, was the one coat ERC system containing 5% TCP. The control failed at 96 hours. (FIG. 1).

The Examples demonstrate the ability of TCP providing corrosion and reflectance benefits in a one coat system, improving the potential for a white elastomeric roof coating system.

The breadth and scope of the present disclosure should not be limited by any of the above-described exemplary embodiments, but should be defined only in accordance with the following claims and their equivalents.

1. A coating composition comprising a binder and a anhydrous tricalcium phosphate (TCP) multifunctional additive selected from the group consisting of Ca₅OH(PO₄)₃, Ca₁₀(OH)₂(PO₄)₆, and Ca₃(PO₄)₂; wherein the multifunctional additive is in an amount of from about 1% to about 99% (by total weight) of the coating.

2. The coating of claim 1, wherein the multifunctional additive is in an amount of about 5% (by total weight) to about 20% (by total weight) of the coating.

3. The coating of claim 1, wherein the TCP multifunctional additive is a high surface area, micronized TCP multifunctional additive.

4. The coating of claim 1, wherein the TCP multifunctional additive has a particle size range of D₅₀ (1-5) micrometers and/or D₉₀ (10-100) micrometers.

5. The coating of claim 1, wherein the TCP multifunctional additive has a refractive index of about 1.5 to about 1.7.

6. The coating of claim 1, wherein the TCP multifunctional additive has a specific surface area of 50 m²/g to 65 m²/g.

7. The coating of claim 1, wherein the binder comprises an acrylic elastomer, resin, silicone, butyl rubber, styrenated acrylic elastomers, or polyurethane.

8. The coating of claim 1, wherein the coating is an elastomeric roof coating.

9. The coating of claim 1, wherein the coating comprises a pigment that is not the TCP multifunctional additive.

10. (canceled)

11. The coating of claim 9, where the pigment that is not the TCP multifunctional additive is titanium dioxide (TiO₂).

12. The coating of claim 9, wherein the pigment that is not the TCP multifunctional additive is an infrared reflective heavy metal pigment.

13. A method of producing a solar reflective coating, the method comprising incorporating a high surface area, micronized anhydrous TCP multifunctional additive into the coating's formulation.

14. (canceled)

15. The method of claim 13, wherein the coating is the coating composition of claim 1.

16. A method of improving the performance of a coating, the method comprising incorporating a high surface area, micronized anhydrous TCP multifunctional additive into the coating's formulation.

17. (canceled)

18. The method of claim 16, wherein the improved coating has the composition of claim 1.

19. A method of coating a substrate, the method comprising applying the coating composition of claim 1 to a surface of the substrate.

20-25. (canceled)

26. A roof surface, wherein the surface is adhered to a coating composition of claim 1.

27-40. (canceled)

41. The coating of claim 1, wherein the TCP multifunctional additive has a particle size range of D₉₀ (10-25) micrometers.

42. The coating of claim 1, wherein the TCP multifunctional additive has a refractive index of about 1.6.

43. The coating of claim 1, wherein the TCP multifunctional additive has a specific surface area of 59.92 m²/g.
